(19) United States
(12) Patent Application Publication
(10) Pub. No.: US 2009/0273831 A1
(43) Pub. Date: Nov. 5, 2009

(54) LIGHT MODULE, OPTICAL TWEEZERS GENERATOR AND DARK FIELD MICROSCOPE

(75) Inventors: Long Hsu, Hsinchu City (TW); Kuang-Lung Huang, Taichung County (TW); William Wang, Taoyuan County (TW); Cheng-Hsien Liu, Hsinchu City (TW); Yuh-Shyong Yang, Hsinchu City (TW); Che-Liang Tsai, Taichung County (TW); Chung-Cheng Chou, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignees: Long Hsu, Hsinchu City (TW); Cheng Hsien, Hsinchu City (TW); Yuh-Shyong Yang, Hsinchu City (TW); RAYDIUM SEMICONDUCTOR CORPORATION, Hsinchu (TW)

(21) Appl. No.: 12/432,876

(22) Filed: Apr. 30, 2009

(30) Foreign Application Priority Data
May 5, 2008 (TW) 97116541

(51) Int. Cl. G02B 21/10; H05H 3/00

(52) U.S. Cl. 359/387; 250/251

(57) ABSTRACT

A light module is provided. The light module applied to a dark field microscope is used for illuminating an object. The light module includes a light beam, a reflection component and a condensing component. The light beam has several lights. The reflection component is used for converting the lights radiating along a beginning direction to a circular beam substantially radiating along the beginning direction. The circular beam passes through the condensing component and is focused on the object. A part of the circular beam passing through the condensing component is scattered by the object.

This application claims the benefit of Taiwan application Serial No. 97116541, filed May 5, 2008, the subject matter of which is incorporated herein by reference.

### BACKGROUND OF THE INVENTION

1. Field of the Invention

The invention relates in general to a light module, an optical tweezers generator and a dark field microscope, and more particularly to a light module, an optical tweezers generator and a dark field microscope capable of reducing the loss rate of the light.

2. Description of the Related Art

Referring to FIG. 1, a perspective of a conventional dark field microscope is shown. The conventional dark field microscope 100 includes a light source 110, a condensing lens 120, a dark field stop 130, a carrier 140 and a lens 150. The dark field stop 130, the condensing lens 120, the carrier 140 and the lens 150 are sequentially disposed in front of the light source 110. The light source 110 emits source light 111. The dark field stop 130 is used for blocking the middle part of the source light 111 emitted by the light source 110 (i.e. blocked light 112) so that the blocked light 112 cannot reach the condensing lens 120. Thus, the blocked light 112 becomes a loss. However, the surrounding part of the source light 111 (i.e. the surrounding light 114) can enter the condensing lens 120 at a large angle of inclination. Thus, the surrounding light 114 will work as an illuminating light toward the object 141 to be examined.

The surrounding light 114 passing through the condensing lens 120 illuminates the field of view of the microscope. Some of the illuminating light 114 is scattered by the object 141 to be examined. The scattered light 116 can enter the lens 150 to form an image of the object 141 behind. However, the rest of the illuminating light 114 that is not scattered by the object 141 will propagate straight and does not enter the lens 150 because of its large angle of inclination. In another words, the unscattered light 115 will not contribute to the image as a background noise. Thus, the image displayed by the dark field microscope 100 shows a bright object with a dark background. Therefore, the image of the dark field microscope is clearer than that of a bright field microscope because of high-contrast. Unfortunately, the conventional dark field microscope 100 has the following disadvantages.

Firstly, the brightness of the image is low. In order to display an image of the object with a high contrast, the dark field stop 130 blocks most of the source light 111. Thus, only the surrounding light 114 which is a small part of the source light 111 is allowed to enter the condensing lens 120, illuminate the object, and form the image. Typically, the loss rate of the source light 111 blocked by the dark field stop 130 is as high as 80%. As the loss rate of the light is high, less light illuminates the object 141. Consequently, the brightness of the image is low.

Secondly, both the magnification and the resolution of the conventional dark field microscope are low. To prevent the unsacttered light 115 from entering the lens 150, the numerical aperture (NA) of the lens 150 needs to be smaller than that of the condensing lens 120. Therefore, it is necessary for the conventional dark field microscope 100 to sacrifice the magnification of the lens 150 and thus the resolution of the image. Consequently, both the magnification and the resolution of the image are low.

### SUMMARY OF THE INVENTION

The invention is directed to a light module, an optical tweezers generator and a dark field microscope. In order to reduce the loss rate of the source light, the light module is invented to convert all of source light into a circular beam. Particularly, the circular beam passes through the light module and is highly focused to illuminate an object to be examined at a large inclination angle. Thus, the brightness, the magnification, and the resolution of the invented dark field microscope are high. On the other hand, because the circular beam completely passes through the condensing component and is highly focused to illuminate the object at a large inclination angle, the light module also generates a trapping force onto the object like an optical tweezers generator.

Firstly, the present invention provides a light module. The light module is applied to the invented dark field microscope for illuminating an object to be examined. The light module mainly consists of a reflection component and a condensing component. The reflection component is used to convert all of an incident light beam into a circular beam. Particularly, the circular beam completely passes through the condensing component and is highly focused to illuminate the object at a large inclination angle.

Secondly, the present invention provides an optical tweezers generator as well. The optical tweezers generator makes use of the same components of the invented dark field microscope, which includes the reflection component and the condensing component. The reflection component is used to covert all of a laser beam into a circularly hollow beam. Particularly, the circularly hollow beam completely passes through the condensing component and is highly focused onto the object at a large inclination angle.

The invention will become apparent from the following detailed description of the preferred but non-limiting embodiments. The following description is made with reference to the accompanying drawings.

### BRIEF DESCRIPTION OF THE DRAWINGS

FIG. 1 shows a perspective of a conventional dark field microscope;

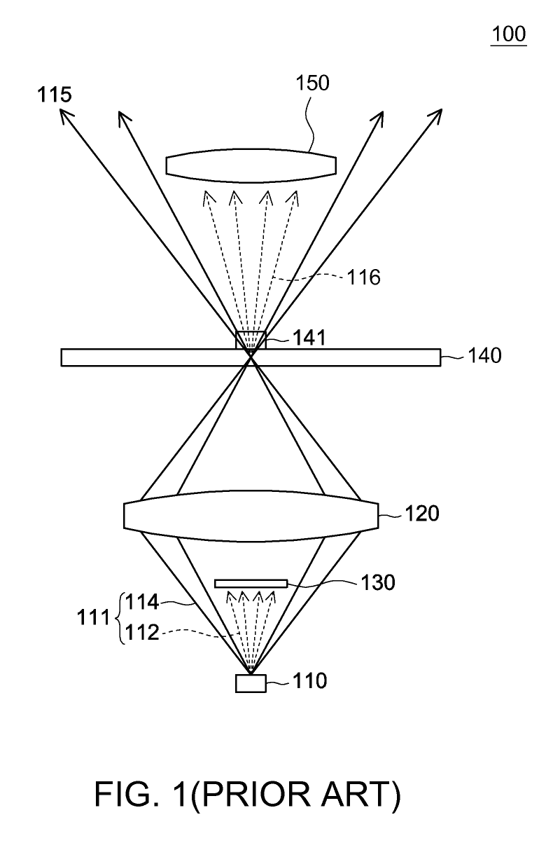

FIG. 2 shows a cross-sectional view of a dark field microscope according to a preferred embodiment of the invention; and

FIG. 3 shows a 3-D perspective of an illuminating light and a reflection component of FIG. 2.

### DETAILED DESCRIPTION OF THE INVENTION

According to the light module, the optical tweezers generator and the dark field microscope of the invention, an incident illuminating light beam is converted into a circular beam for illuminating the object to be examined. Meanwhile, the object may be trapped by a laser beam incident into this light module, simultaneously. The invention is disclosed below by way of embodiments.

Illuminating Object

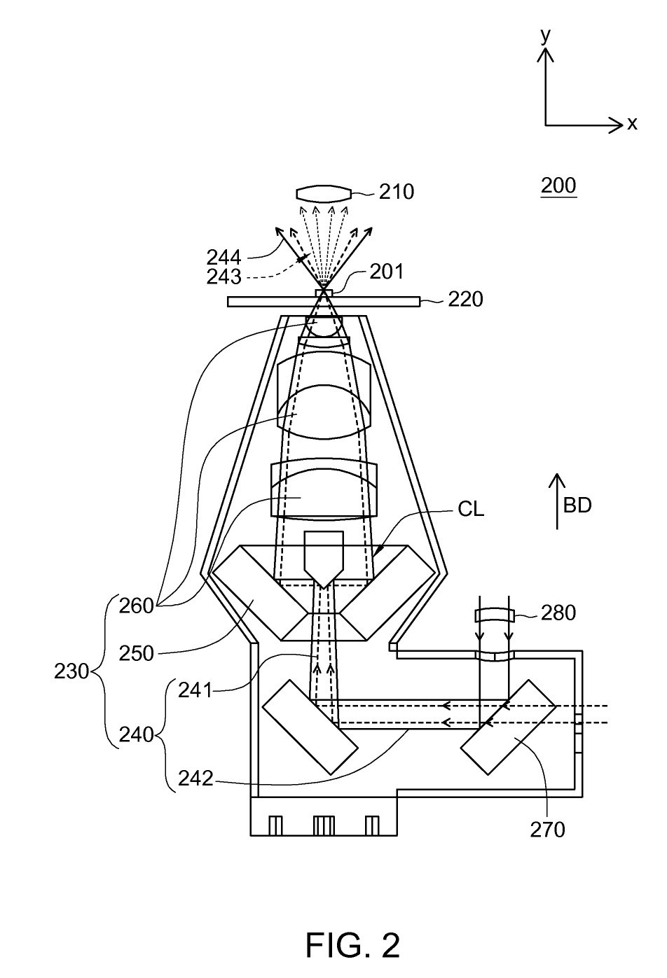

Referring to FIG. 2, a cross-sectional view of a dark field microscope according to a preferred embodiment of the invention is shown. The dark field microscope 200 used for examining an object 201 includes a lens 210, a carrier 220 and a light module 230. The carrier 220 used for carrying the object 201 is disposed between the lens 210 and the light module 230. The light module 230 used for illuminating the object 201 includes a light beam 240, a reflection component 250 and a condensing component 260.

The light beam 240 is a collimated beam and is guided from either of the two entrances of the light module 230 to the reflection component 250 inside. The reflection component 250 is used for converting the light beam 240, which is collimated and sold, to a circular beam CL substantially radiating along the beginning direction BD. The circular beam CL is hollow. The circular beam CL passes through the condensing component 260 and is focused onto the object 201. Preferably, the circular beam CL passes through the edge of the condensing component 260. Thus, the circular beam CL is focused on the object 201 at a large angle of inclination. A large portion of the circular beam CL is scattered by the object 201. The scattered light 243 is projected onto an image plane (not illustrated) to form an image of the object 201 by the lens 210. A small portion of the focused circular beam CL is not scattered by the object 201. The unscattered light 244 does not enter the lens 210, and therefore will not contribute to the background noise of the image.

Thus, a high-contrast image of the object 201 is formed behind the lens 210. Besides, the dark field microscope 200 can guide most of the incident collimated beam 240 to illuminate the object 201 via the condensing component 260, thus reducing the loss rate of the light to as low as 5%.

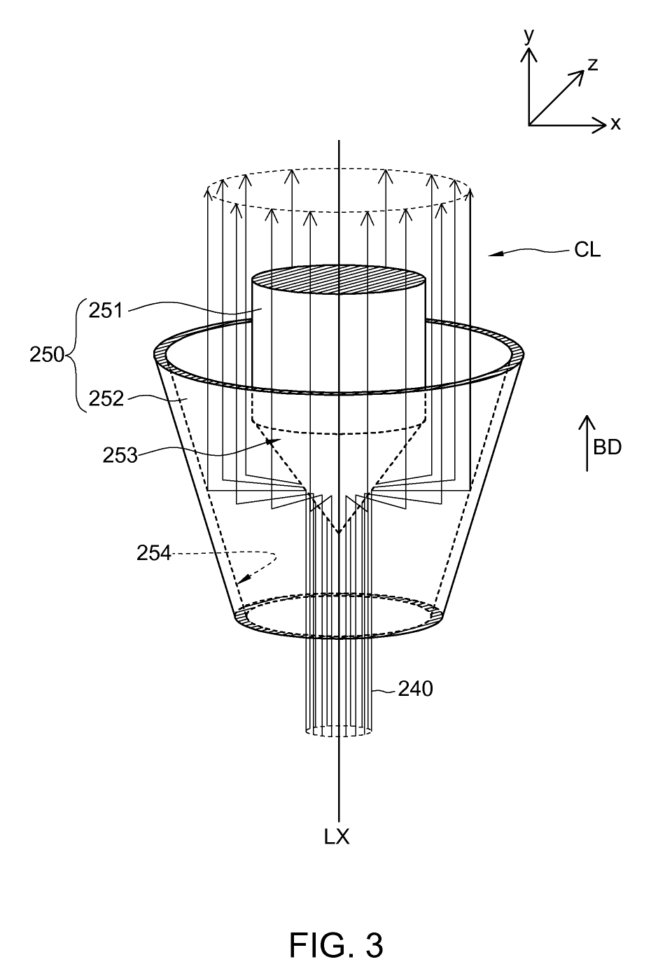

FIG. 3 shows a 3-D perspective of the reflection component 250 and its conversion of the light beam 240 to the circular beam CL. The reflection component 250 includes a first reflection element 251 and a second reflection element 252. The first reflection element 251, being cone-shaped for example, has a first reflection surface 253 and an optical axis LX. The optical axis LX is parallel to the beginning direction BD. The second reflection element 252, being musk-shaped for example, has a second reflection surface 254. The first reflection surface 253 faces the second reflection surface 254. The light beam 240 is reflected from the first reflection surface 253 to the second reflection surface 254. The reflected light from the second reflection surface 254 is in the form of a circular beam CL substantially radiating along the beginning direction BD.

The first reflection element 251 and the second reflection element 252 are preferably coated with a dielectric film (not illustrated) with high reflectivity. In the present embodiment of the invention, the reflection component 250 includes the first reflection element 251 and the second reflection element 252 but is not limited thereto. In practical application, any reflection components capable of guiding the light into a circular beam will do.

In the present embodiment of the invention, the numerical aperture of the condensing component 260 substantially is 1.3, such that the circular beam CL can illuminate the object 201 at a very large angle of inclination. Thus, the contrast and resolution of the image of the object 201 as well as the magnification are increased.

Providing Optical Tweezers

The light module 230 also provides a trapping force to the object 201 like an optical tweezers generator. As indicated in FIG. 2, if the collimated beam 240 is from a laser source, for example, the reflection component 250 also converts the laser beam 241 into the circular beam CL substantially radiating along the beginning direction BD. The circular beam CL passes through the condensing component 260 and is highly focused on the object 201. The object 201 such as a particle or cell can thus be trapped according to the theory of optical tweezers.

The optical tweezers, being a non-mechanical operating technology, is neither invasive nor destructive to the object 201. After, the reflection component 250 converts the laser beam 241 into a circular beam CL, the circular beam CL is able to pass through the condensing component 260 to the object 201. Thus, a large gradient force is provided to trap and manipulate the object 201.

Besides, the numerical aperture of the condensing component 260 can be as high as 1.3, so that the circular beam CL is focused on the object 201 at a considerable large angle of inclination.

Preferably, the light module 230 has at least one dichroic mirror 270 of high reflection at a particular wavelength. In the present embodiment of the invention, two dichroic mirrors 270 are used for reflecting the laser beam 241 toward the reflection component 250.

Concurrently Illuminating Object and Providing Optical Tweezers

The light module 230 can be used to illuminate the object 201 and at the same time exert a trapping force of optical tweezers to the object 201. The reflection component 250 converts the illuminating light 241 into the circularly hollow beam CL substantially radiating along the beginning direction BD. The circular beam CL passes through the edge of the condensing component 260, thus the circular beam CL is focused onto the object 201 with a large angle of inclination. Meanwhile, most of the focused circular beam CL is scattered by the object 201. The scattered light 243 is projected onto an image plane (not illustrated) to form an image of the object 201 by the lens 210. At the same time, a trapping force of optical tweezers is exerted to the object 201.

Due to chromatic aberration, the location of the image of the object 201 formed by the dark field microscope 200 will vary with wavelength. Similarly, the location of the trapping point focused by the optical tweezers generator varies with wavelength. In order to adjust this aberration, in the present embodiment of the invention an achromatic lens 280 is adopted in the light module 230. By doing so, the module 230 may create an image of the object 201 at the same image plane with the laser beam 242 of any wavelength. Similarly, the light module 230 may generate a trapping point of optical tweezers at the same location.

According to the light module, the optical tweezers generator and the dark field microscope of the invention, a light beam is converted into a circular hollow beam. The circular beam passes through the condensing component and is focused on the object. Since the light module reserves nearly all the incident light beam for illumination, the image of the object will have a high brightness. In addition, because of the large inclination angle of the illuminating light, the object also has a high contrast, magnification, and resolution image. Moreover, as the light of the light beam is effectively used to illuminate the object or provide an optical tweezers, the loss rate of the light is reduced. Besides, as the numerical aperture of the condensing component substantially is 1.3, the circular beam is able to pass through the condensing component with a tremendously large angle of inclination. Because of the large angle of inclination, the circular beam and the highly focused laser beam generates a trapping force onto the object within the field of view of the invented dark field microscope.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light module applied to a dark field microscope and used for illuminating an object, wherein the light module comprises:
a light beam having a plurality of lights;
a reflection component used for converting the lights radiating along a beginning direction to a circular beam substantially radiating along the beginning direction, the circular beam being hollow; and
a condensing component, wherein the circular beam passes through the condensing component and is focused on the object, and a part of the circular beam passing through the condensing component is scattered by the object.

2. The light module according to claim 1, wherein the circular beam passes through the edge of the condensing component.

3. The light module according to claim 1, wherein the reflection component comprises:
a first reflection element having a first reflection surface and an optical axis parallel to the beginning direction; and
a second reflection element having a second reflection surface, wherein the first reflection surface faces the second reflection surface;
wherein each light radiating along the beginning direction is reflected to the second reflection surface from the first reflection surface in a reflection direction departing from the optical axis and reflected to the beginning direction from the second reflection surface to form the circular beam.

4. The light module according to claim 3, wherein the reflection direction is substantially perpendicular to the beginning direction.

5. The light module according to claim 3, wherein the first reflection element is cone-shaped, and the second reflection element is musk-shaped.

6. The light module according to claim 3, wherein the first reflection element and the second reflection element are coated with a dielectric film.

7. The light module according to claim 1, further providing an optical tweezers exerting a trapping force to the object, wherein a part of the lights are laser lights, and the circular beam passes through the condensing component and is focused on the object to form the optical tweezers having the trapping force.

8. The light module according to claim 7, further comprising:
an achromatic lens used for adjusting the aberration of the laser lights before the laser lights are projected onto the reflection component.

9. The light module according to claim 7, further comprising:
a dichroic mirror used for filtering the wavelength of the laser lights before the laser lights are projected onto the reflection component.

10. The light module according to claim 1, wherein the numeric aperture of the condensing component substantially is 1.3.

11. An optical tweezers generator used for providing an optical tweezers exerting a trapping force to an object, wherein the optical tweezers generator comprises:
a light beam having a plurality of laser lights;
a reflection component used for converting the laser lights radiating along a beginning direction to a circular beam substantially radiating along the beginning direction, the circular beam being hollow; and
a condensing component, wherein the circular beam passes through the condensing component and is focused on the object to form the optical tweezers having the trapping force.

12. The optical tweezers generator according to claim 11, wherein the circular beam passes through the edge of the condensing component.

13. The optical tweezers generator according to claim 11, wherein the reflection component comprises:
a first reflection element having a first reflection surface and an optical axis, wherein the optical axis is parallel to the beginning direction; and
a second reflection element having a second reflection surface, wherein the first reflection surface faces the second reflection surface;
wherein each laser light radiating along the beginning direction is reflected to the second reflection surface from the first reflection surface in a reflection direction departing from the optical axis and reflected to the beginning direction from the second reflection surface to form the circular beam.

14. The optical tweezers generator according to claim 13, wherein the reflection direction is substantially perpendicular to the beginning direction.

15. The optical tweezers generator according to claim 13, wherein the first reflection element is cone-shaped and the second reflection element is musk-shaped.

16. The optical tweezers generator according to claim 13, wherein the first reflection element and the second reflection element are coated with a dielectric film.

17. The optical tweezers generator according to claim 11, wherein the light beam further comprises a plurality of illuminating lights, the circular beam passes through the condensing component and is focused on the object, and a part of the circular beam passing through the condensing component is scattered by the object.

18. The optical tweezers generator according to claim 11, further comprising:
an achromatic lens used for adjusting the aberration of the laser lights before the laser lights are projected onto the reflection component.

19. The optical tweezers generator according to claim 11, further comprising:
a dichroic mirror used for filtering the wavelength of the laser lights before the laser lights are projected onto the reflection component.

20. The optical tweezers generator according to claim 11, wherein the numeric aperture of the condensing component substantially is 1.3.

21. A dark field microscope, used for examining an object, the dark field microscope comprises:
a lens;
a carrier used for carrying the object; and
a light module used for illuminating the object, wherein the carrier is disposed between the lens and the light module, and the light module comprises:
a light beam having a plurality of lights;
a reflection component used for converting the lights radiating along a beginning direction to a circular beam substantially radiating along the beginning direction; and
a condensing component, wherein the circular beam passes through the condensing component and is focused on the object, and a part of the circular beam passing through the condensing component is scattered by the object to form an image by the lens.

22. The dark field microscope according to claim 21, wherein the circular beam passes through the edge of the condensing component.

23. The dark field microscope according to claim 21, wherein the reflection component comprises:
a first reflection element having a first reflection surface and an optical axis, wherein the optical axis is parallel to the beginning direction; and
a second reflection element having a second reflection surface, wherein the first reflection surface faces the second reflection surface;
wherein each light radiating along the beginning direction is reflected to the second reflection surface from the first reflection surface in a reflection direction departing from the optical axis and reflected to the beginning direction from the second reflection surface to form the circular beam.

24. The dark field microscope according to claim 23, wherein the reflection direction is substantially perpendicular to the beginning direction.

25. The dark field microscope according to claim 23, wherein the first reflection element is cone-shaped and the second reflection element is musk-shaped.

26. The dark field microscope according to claim 23, wherein the first reflection element and the second reflection element are coated with a dielectric film.

27. The dark field microscope according to claim 21, wherein the light module is further used for providing an optical tweezers exerting a trapping force to the object, a part of the lights are laser lights, and the circular beam passes through the condensing component and is focused on the object to form the optical tweezers having the trapping force.

28. The dark field microscope according to claim 27, wherein the light module further comprises:
an achromatic lens used for adjusting the aberration of the laser lights before the laser lights are projected onto the reflection component.

29. The dark field microscope according to claim 27, wherein the light module further comprises:
a dichroic mirror used for filtering the wavelength of the laser lights before the laser lights are projected onto the reflection component.

30. The dark field microscope according to claim 21, wherein the numeric aperture of the condensing component substantially is 1.3.
